(19) United States
(12) Patent Application Publication
(10) Pub. No.: US 2008/0299978 A1
(43) Pub. Date: Dec. 4, 2008

(54) Extending RF coverage areas for cellular telephones using base stations with ultra-wide band signaling

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/809,679

(22) Filed: Jun. 1, 2007

(51) Int. Cl. H04Q 7/32

(52) U.S. Cl. 455/437

(57) ABSTRACT

An exemplary method provides cellular communications for handsets capable of communications using a conventional RF communication mode and a second ultra-wide band RF communication mode. An RF voice communication link is established between the handset and a base station using the conventional communication mode. A decrease in signal strength of the RF link is detected to be at a level at which a hand-off should be made. No other base stations utilizing the conventional communication mode have an acceptable signal strength level with the handset to support a hand-off from the base station. Another base station using the ultra-wide band second communication mode has an acceptable signal strength level with the handset to support a hand-off from the current base station. A hand-off of the voice communication link with the handset is made from the current base station to the other base station, where the handset changes from using the conventional RF communication mode to the ultra-wide band RF communication mode.

### BACKGROUND

This invention relates to radio frequency (RF) service for cellular telephones and more specifically to extending RF coverage for cellular telephones that enter areas of degraded RF signal levels.

With cellular telephones being in widespread use, customers expect their cellular telephones to provide communication services regardless of their location. Although cellular service providers have deployed an increasing number of base stations in an attempt to work toward the goal of providing 100% RF coverage and hence continuous communication services for subscribers, certain environments degrade RF signals to a level where communications services can no longer be supported. Certain interior locations within buildings, underground tunnels and parking garages are examples of such environments in which RF signals are often degraded to a level at which communications cannot be supported. For a cellular subscriber in an ongoing telephone call, entering such an environment results in a dropped call. For a cellular subscriber desiring to initiate a call in such an environment, no service will be available.

Even adding another base station near such an environment does not always solve the low RF signal level problem. Although the additional base station may be physically closer to the subject environment, the additional base station utilizes the same range of frequencies and signaling characteristics of the other base stations. The nearer base station may provide a somewhat increased power level to the exterior of the subject environment, but does not provide a different RF penetration pattern into the interior environment where the cellular subscriber is present since it uses the same frequency range and signaling characteristics as the other base stations. Therefore, a need exists for a solution that will minimize cellular service disruptions especially in environments where RF coverage is difficult for conventional base stations.

### SUMMARY

It is an object of the present invention to satisfy this need.

An exemplary method provides cellular communications for handsets capable of communications using a conventional RF communication mode and a second ultra-wide band RF communication mode. An RF voice communication link is established between the handset and a base station using the conventional communication mode. A decrease in signal strength of the RF link is detected to be at a level at which a hand-off should be made. No other base stations utilizing the conventional communication mode have an acceptable signal strength level with the handset to support a hand-off from the base station. Another base station using the ultra-wide band second communication mode has an acceptable signal strength level with the handset to support a hand-off from the current base station. A hand-off of the voice communication link with the handset is made from the current base station to the other base station, where the handset changes from using the conventional RF communication mode to the ultra-wide band RF communication mode.

A system including base stations and a mobile switching center supports the above method.

### DESCRIPTION OF THE DRAWINGS

Features of exemplary implementations of the invention will become apparent from the description, the claims, and the accompanying drawings in which:

FIG. 1 is a block diagram of a cellular communication system suited for incorporation of an embodiment of the present invention.

FIG. 2 is a flow diagram of steps in accordance with an illustrative method of an embodiment of the present invention.

### DETAILED DESCRIPTION

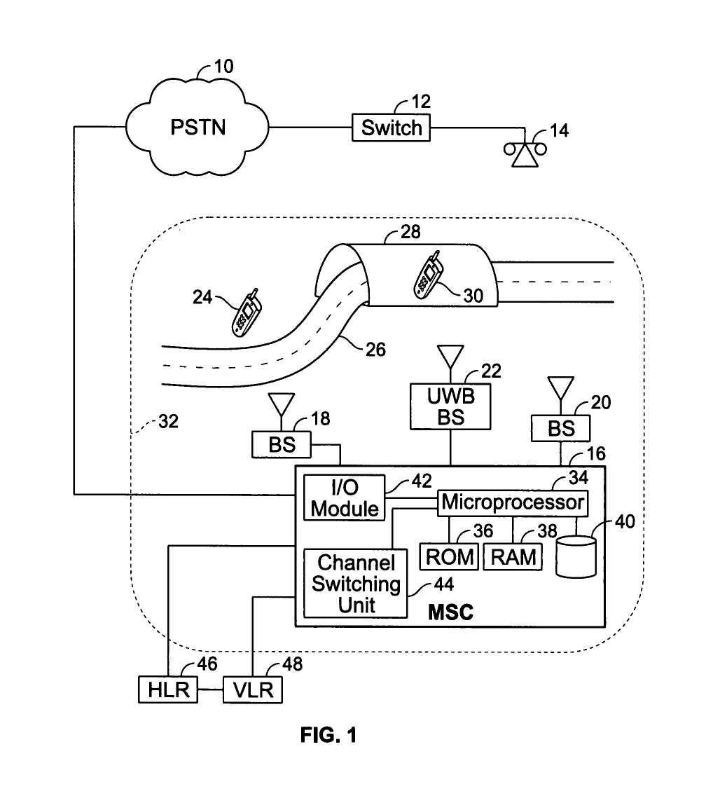

FIG. 1 shows an exemplary telecommunication system suited for incorporation of an embodiment of the present invention. The public switched telephone network (PSTN) 10 supports a plurality of telecommunication switches of which switch 12 is exemplary. A plurality of telephone subscribers are provided communication services by switch 12 over common wire lines coupled to a conventional telephone instrument 14.

Cellular communication services are supported by a mobile switching center (MSC) 16 that is coupled to the PSTN 10. Known conventional base stations 18 and 20 provide RF transmission and reception capabilities, e.g. code division multiple access (CDMA), for a plurality of assigned communication channels. In accordance with an embodiment of the present invention, an exemplary base station 22 employs an RF transmission and reception technique that differs from base stations 18 and 20. The station 22 utilizes ultra-wide band (UWB) radio technology. As used herein, “UWB radio technology” refers to RF transmissions defined in accordance with the definition of same provided by the Federal Communications Commission, e.g. RF transmissions having a bandwidth the lesser of 500 MHz or 20% of the center frequency. The FCC has authorized the unlicensed use of UWB in the 3.1-10.6 GHz range.

A portable cellular subscriber handset 24 is located near road 26. In this illustrative example it is assumed that the cellular subscriber is in a car traveling on road 26 towards tunnel 28. Cellular subscriber handset 30 represents handset 24 at a later time within the tunnel 28. Although any of the base stations 18, 20 and 22 can generally serve a cellular subscriber handset within coverage region 32, the underground tunnel 28 is sufficiently long that RF signals from conventional base stations 18 and 20 are sufficiently degraded within the tunnel so as to cause a loss of service when the cellular handset is deep within the tunnel. However, the UWB radio technology utilized by base station 22 provides RF signals that are able to sufficiently penetrate within the tunnel and thereby support radio communications with cellular handsets that are within the tunnel. This will be described in more detail below.

The mobile switching center 16 manages the use of the base stations coupled to it. It includes a microprocessor 34 supported by read-only memory (ROM) 36, random access memory (RAM) 38, and a nonvolatile data storage device such as a hard drive 40. The microprocessor 34 is also supported by an input/output module 42 and a channel switching unit 44. The microprocessor 34 operates under the control of a program of stored instructions. The input/output module 42 provides a communication interface between the microprocessor 34 and external devices, e.g. PSTN and base stations, permitting commands and signaling to be exchanged. The channel switching unit 44 serves to select and connect voice channels among the PSTN and the base stations. For example, a cellular subscriber supported by base station 18 would have a voice channel connected by the channel switching unit 44 with a corresponding cellular subscriber supported by base station 20. Alternatively, a cellular subscriber supported by base station 18 could have a voice channel connected by the channel switching unit 44 by the PSTN with the subscriber associated with telephone 14.

As will be appreciated by those skilled in the art, a home location register (HLR) 46 and a visiting location register (VLR) 48 are coupled to the mobile switching center 16. These registers service the cellular subscribers and function to provide identification, authentication and location services.

In this example, CDMA cellular signaling is utilized for normal communications between cellular handset 24/30 and conventional base stations 18 and 20. UWB RF signaling is utilized for communications between base station 22 and the cellular handset 24/30. The cellular handset 24/30 is capable of communications utilizing either conventional cellular CDMA signaling or UWB signaling, and is preferably capable of concurrent communications in both modes.

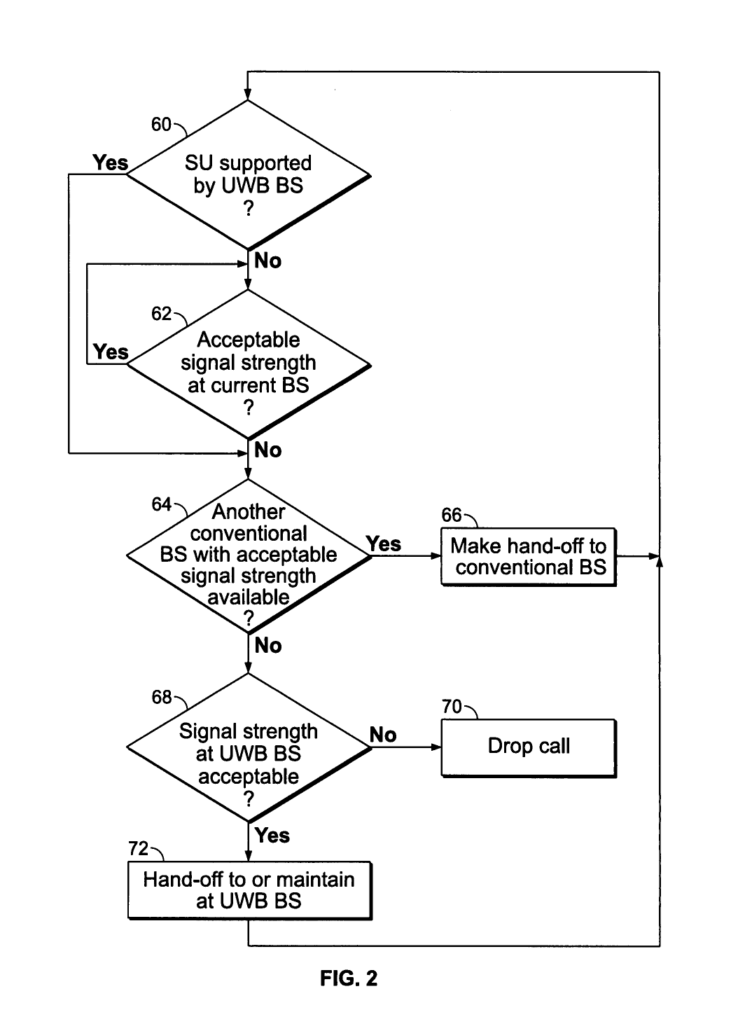

FIG. 2 is a flow diagram of steps of the illustrative embodiment of a method in accordance with the present invention. This method describes a process of determining whether a conventional base station or a UWB base station is selected to provide support to a subscriber unit (SU). In step 60 a determination is made of whether the SU is supported by a UWB base station. The decisions and actions described in this figure may be made by the mobile switching center in combination with the information received from the base stations and VLR. Alternatively, the handset may be capable of monitoring signal strengths for both modes and make hand-off requests. A NO determination by step 60 results in further processing by step 62 in which a determination is made of whether acceptable signal strength is available at the current base station. A YES determination by step 62 results in processing returning to the beginning of step 62 where the signal strength is continued to be checked to determine that it is acceptable.

A YES determination by step 60 or a NO determination by step 62 results in further processing at step 64 in which a determination is made of whether another conventional, i.e. non-UWB, base station with acceptable signal strength is available. A YES determination by step 64 results in a hand-off being made to the conventional base station with acceptable signal strength as indicated at step 66. Following step 66, processing returns to the beginning at the input of step 60.

A NO determination by step 64, representing that a conventional base station with acceptable signal strength is not available, causes a decision to be made of whether a signal strength at a UWB base station is acceptable. A NO determination by step 68 results in the call being dropped as indicated at step 70. That is, determinations were made that no conventional or UWB base station was available with sufficient signal strength to support a call. A YES determination by step 68 results in the UWB base station providing service to the subject SU at step 72. In accordance with step 72, if the subject SU was previously supported by a conventional base station, then a hand-off is made to the UWB base station. If the subject SU was previously supported by the UWB base station, then the support of services for the SU is maintained by the UWB base station. Following processing by step 72, control returns to the beginning at the input of step 60.

In accordance with the above method preference is given to serving the cellular subscriber by a conventional base station. This permits a smaller relative number of UWB base stations to be used, hence the bandwidth of the UWB base stations is conserved. It is envisioned that the general service area for a UWB base station will be similar to that of conventional base stations, e.g. one or more square miles. Although the UWB base station serves a similar area, the ability of the UWB signal to penetrate into difficult RF environments will result in fewer dropped calls for subscribers. It will be noted that a hand-off will be made to a conventional base station having sufficient signal strength even if the signal strength of a handset to UWB base station link is still acceptable in order to minimize the load on the UWB base station.

Referring to FIG. 1, an example is explained wherein the subscriber associated with cellular handset 24 is driving along road 26 towards the tunnel 28. Prior to entering the tunnel, handset 24 is served by base station 18 although both base stations 20 and 22 have acceptable signal strength and could be utilized for communications with the handset 24. Upon entering the tunnel, the signal strength with base station 18 begins to decrease rapidly and hence a hand-off consideration arises. A hand-off would have been made to base station 20 except that the signal strength at station 20 may also be decreasing rapidly. Although the signal strength at UWB base station 22 has decreased somewhat, there is still sufficient signal strength to support ongoing communications due to better signal penetration into the tunnel. Thus, the MSC 16 initiates a hand-off of the ongoing communication with handset 24/30 from base station 18 to base station 22. In addition to the change of the supporting base station, the handset itself changes mode from normal CDMA communications to UWB communications in accord with the hand-off. At this stage the handset is represented as handset 30 which resides within the tunnel. Communications are maintained with the handset by base station 22. As the subscriber nears the exit of the tunnel, the signal strength as detected by base station 22 begins to increase rapidly. In one embodiment the handset continues to poll for an acceptable CDMA signal while in the UWB mode and upon leaving the tunnel, the handset will detect that acceptable signals are available from the base stations 18 and/or 20. In another embodiment the UWB base station may use increasing signal strength from the handset to alert the CDMA base stations in the same area to poll for the subject handset in order to determine if an acceptable CDMA signal is now available. Once one of base stations 18 and 20 is determined to have an acceptable signal strength to support ongoing communications with the handset, it will be selected by the MSC 16 to receive a hand-off of the ongoing call from base station 22.

Although exemplary implementations of the invention have been depicted and described in detail herein, it will be apparent to those skilled in the art that various modifications, additions, substitutions, and the like can be made without departing from the spirit of the invention. For example, the steps in the exemplary method can be modified, rearranged and/or deleted while still achieving a desired goal. A single base station can support communications using both UWB and another conventional cellular signaling technique. The transition to UWB communications could also be used to extend the range of coverage outside of a conventional cellular cell boundary such as when a subscriber is exiting an outer most cell in a region in a direction away from the cells.

The scope of the invention is defined in the following claims.

We claim:

1. A method for providing cellular communications for handsets capable of communications using a first radio frequency (RF) communication mode and a second ultra-wide band RF communication mode comprising the steps of:
establishing an RF voice communication link between the handset and a first base station using the first communication mode;
detecting a decrease in signal strength of the RF link to a level at which a hand-off should be made;
determining that no other base stations utilizing the first communication mode have an acceptable signal strength level with the handset to support a hand-off from the first base station;
determining that a second base station using the ultra-wide band second communication mode has an acceptable signal strength level with the handset to support a hand-off from the first base station;
making a first hand-off of the voice communication link with the handset from the first base station to the second base station, where the handset changes from using the first RF communication mode to the second ultra-wide band RF communication mode.

2. The method of claim 1 further comprising the steps of:
monitoring to determine whether an acceptable signal strength level between the handset and one of the base stations using the first communication mode exists to support a second hand-off of the voice communication link from the second base station to the one base station;
upon determining that an acceptable signal strength level between the handset and the one of the base stations exists to support a second hand-off of the voice communication link from the second base station to the one base station, making the second hand-off of the voice communication link with the handset from the second base station to the one base station, where the handset changes from using the ultra-wide band RF communication mode to the first RF communication mode.

3. The method of claim 2 wherein the second hand-off of the voice communication link with the handset from the second base station to the one base station is made even if the signal strength between the handset and the second base station prior the second hand-off has not decreased to a level at which a hand-off should be made.

4. The method of claim 1 wherein a mobile switching center controls the making of the hand-off.

5. The method of claim 1 where both of the determining steps are implemented by the handset.

6. The method of claim 1 wherein the first and second base stations are located so as to have substantially overlapping communication coverage areas.

7. A system that provides cellular communications for handsets capable of communications using a first radio frequency (RF) communication mode and a second ultra-wide band RF communication mode comprising:
a first base station that supports communications using a first RF communication mode and a second base station that supports communications using a second ultra-wide band RF communication mode;
the first base station having an ongoing RF voice communication link with the handset using the first communication mode;
a mobile switching center (MSC) is coupled to the base stations and supports communications with handsets served by the base stations;
the handset senses a decrease in signal strength of the RF link to a level at which a hand-off should be made and transmits a request for a hand-off to the MSC;
the MSC determines that no other base stations utilizing the first communication mode have an acceptable signal strength level with the handset to support a hand-off from the first base station;
the MSC determines that a second base station using the ultra-wide band second communication mode has an acceptable signal strength level with the handset to support a hand-off from the first base station;
the MSC causes a first hand-off of the voice communication link with the handset from the first base station to the second base station, where the handset changes from using the first RF communication mode to the second ultra-wide band RF communication mode.

8. The system of claim 7 further comprising:
the handset monitors to determine whether an acceptable signal strength level between the handset and one of the base stations using the first communication mode exists to support a second hand-off of the voice communication link from the second base station to the one base station;
upon the handset determining that an acceptable signal strength level between the handset and the one of the base stations exists to support a second hand-off of the voice communication link from the second base station to the one base station, the handset transmits a handoff request to the MSC and the MSC causes the second hand-off of the voice communication link with the handset from the second base station to the one base station, where the handset changes from using the ultra-wide band RF communication mode to the first RF communication mode.

9. The system of claim 8 wherein the MSC causes the second hand-off of the voice communication link with the handset from the second base station to the one base station to be made even if the signal strength between the handset and the second base station prior the second hand-off has not decreased to a level at which a hand-off should be made.

10. The system of claim 7 wherein the first and second base stations are located so as to have substantially overlapping communication coverage areas.
